(19) United States
(12) Patent Application Publication
(10) Pub. No.: US 2017/0323433 A1
(43) Pub. Date: Nov. 9, 2017

(54) METHOD, APPARATUS AND COMPUTER PROGRAM PRODUCT FOR GENERATING SUPER-RESOLVED IMAGES

(71) Applicant: Nokia Technologies Oy, Espoo (FI)

(72) Inventors: Soumik Ukil, Bangalore (IN); Basavaraja S V, Bangalore (IN)

(21) Appl. No.: 15/529,453

(22) PCT Filed: Nov. 20, 2015
(86) PCT No.: PCT/FI2015/050807

§ 371 Date: May 24, 2017

(30) Foreign Application Priority Data
Nov. 27, 2014 (IN) 5952/CHE/2014

(51) Int. Cl. G06T 5/20; G06T 3/40; G06T 5/50

(52) U.S. Cl. CPC G06T 5/20; G06T 5/50; G06T 3/4053; G06T 2207/20024

(57) ABSTRACT

In an example embodiment a method, apparatus and computer program product are provided. The method includes generating an initial super-resolved image associated with a scene based on a reference image and remaining one or more images of a plurality of images of the scene, where the scene comprising at least one mobile object. The reference image is up-sampled to generate an up-sampled reference image. A motion mask image is generated based on the initial super-resolved image and the up-sampled reference image. Based on the motion mask image, a composite image of the scene including at least one portion depicting the at least one mobile object is generated.

### TECHNICAL FIELD

Various embodiments, relate generally to method, apparatus, and computer program product for generating super-resolved images.

### BACKGROUND

Various electronic devices such as cameras, mobile phones, and other devices are widely used for capturing media content, such as images and/or videos of a scene. In order to capture high-resolution media content, the images/frames of the media content may be registered with respect to a reference image/frame, so as to generate a super-resolved image. The super-resolved images may be generated by a technique known as multi-frame image super-resolution. In multi-frame image super-resolution technique, several noisy low-resolution images of the same scene may be acquired under different conditions, and processed together, to thereby generate one or more high-quality super-resolved images. Such super-resolved images may be utilized in a multitude of applications such as satellite terrain imagery, medical images, surveillance applications, and so on.

The super-resolved images may be associated with higher spatial frequency, and less noise and image blur than any of the original images that are utilized for generating the super-resolved images. However, in case the scene includes a mobile object (or an object in motion), then the super-resolved image of the scene may include motion artifacts. This may be attributed to the fact that the registration across images/frames handles only global motion and not the local motion associated with the scene. In some scenarios, techniques may be applied for handling local motion as well, however such techniques are time-consuming and computationally intensive.

### SUMMARY OF SOME EMBODIMENTS

Various example embodiments are set out in the claims.

In a first embodiment, there is provided a method comprising: generating an initial super-resolved image associated with a scene based on a reference image and remaining one or more images of a plurality of images of the scene, the scene comprising at least one mobile object; up-sampling the reference image to generate an up-sampled reference image; generating a motion mask image based on the super-resolved image and the up-sampled reference image, the motion mask image representative of motion of the at least one mobile object associated with the scene; and generating, based on the motion mask image, a composite image of the scene comprising at least one portion depicting the at least one mobile object.

In a second embodiment, there is provided an apparatus comprising at least one processor; and at least one memory comprising computer program code, the at least one memory and the computer program code configured to, with the at least one processor, cause the apparatus to perform at least: generate an initial super-resolved image associated with a scene based on a reference image and remaining one or more images of a plurality of images of the scene, the scene comprising at least one mobile object; up-sample the reference image to generate an up-sampled reference image; generate a motion mask image based on the super-resolved image and the up-sampled reference image, the motion mask image representative of motion of the at least one mobile object associated with the scene; and generate, based on the motion mask image, a composite image of the scene comprising at least one portion depicting the at least one mobile object.

In a third embodiment, there is provided a computer program product comprising at least one computer-readable storage medium, the computer-readable storage medium comprising a set of instructions, which, when executed by one or more processors, cause an apparatus to perform at least: generate an initial super-resolved image associated with a scene based on a reference image and remaining one or more images of a plurality of images of the scene, the scene comprising at least one mobile object; up-sample the reference image to generate an up-sampled reference image; generate a motion mask image based on the super-resolved image and the up-sampled reference image, the motion mask image representative of motion of the at least one mobile object associated with the scene; and generate, based on the motion mask image, a composite image of the scene comprising at least one portion depicting the at least one mobile object.

In a fourth embodiment, there is provided an apparatus comprising: means for generating an initial super-resolved image associated with a scene based on a reference image and remaining one or more images of a plurality of images of the scene, the scene comprising at least one mobile object; means for up-sampling the reference image to generate an up-sampled reference image; means for generating a motion mask image based on the super-resolved image and the up-sampled reference image, the motion mask image representative of motion of the at least one mobile object associated with the scene; and means for generating, based on the motion mask image, a composite image of the scene comprising at least one portion depicting the at least one mobile object.

In a fifth embodiment, there is provided a computer program comprising program instructions which when executed by an apparatus, cause the apparatus to: generate an initial super-resolved image associated with a scene based on a reference image and remaining one or more images of a plurality of images of the scene, the scene comprising at least one mobile object; up-sample the reference image to generate an up-sampled reference image; generate a motion mask image based on the super-resolved image and the up-sampled reference image, the motion mask image representative of motion of the at least one mobile object associated with the scene; and generate, based on the motion mask image, a composite image of the scene comprising at least one portion depicting the at least one mobile object.

### BRIEF DESCRIPTION OF THE FIGURES

Various embodiments are illustrated by way of example, and not by way of limitation, in the figures of the accompanying drawings in which:

FIG. 1 illustrates a device, in accordance with an example embodiment;

FIG. 2 illustrates an apparatus for generating super-resolved images, in accordance with an example embodiment;

FIGS. 3A-3D represents example steps for super-resolving images associated with a scene, in accordance with an example embodiment;

FIG. 4 is a flowchart depicting an example method for generating a super-resolved image, in accordance with an example embodiment; and

FIG. 5 is a flowchart depicting another example method for generating a super-resolved image, in accordance with another example embodiment.

### DETAILED DESCRIPTION

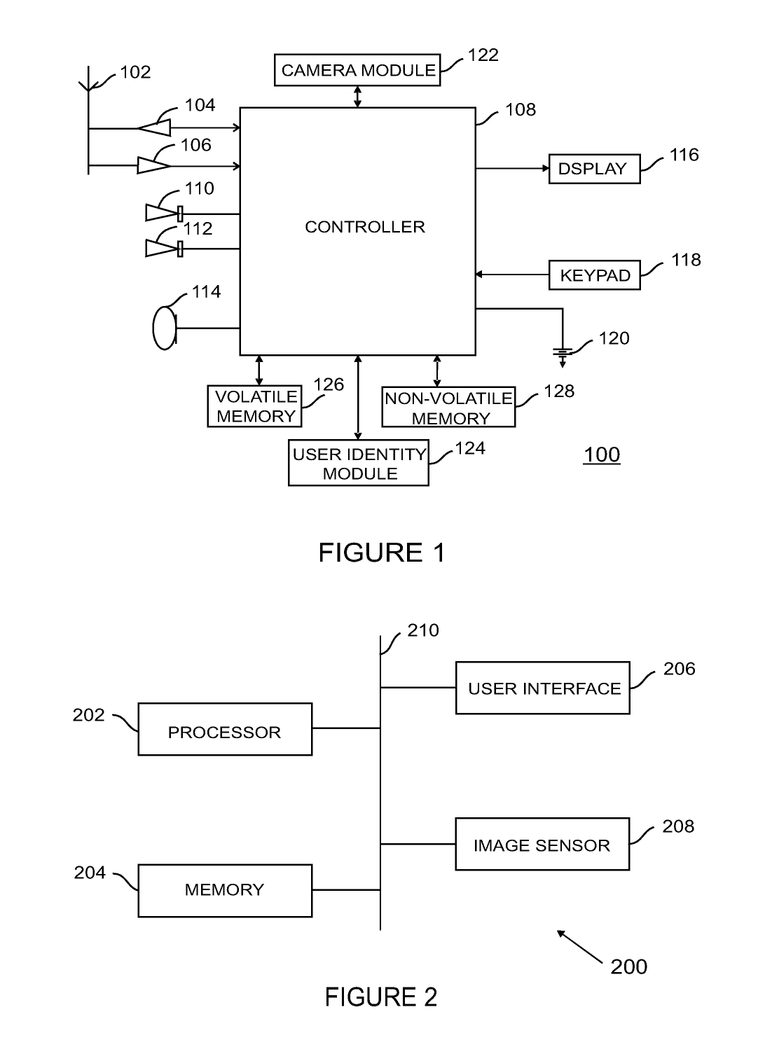

Example embodiments and their potential effects are understood by referring to FIGS. 1 through 5 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means configured for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

FIG. 2 illustrates an apparatus 200 for generating a super-resolved image of a scene, in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices. Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some examples of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the electronic device may include a mobile phone, a personal digital assistant (PDA), and the like. Some examples of computing device may include a laptop, a personal computer, and the like. In an example embodiment, the electronic device may include a user interface, for example, the UI 206, having user interface circuitry and user interface software configured to facilitate a user to control at least one function of the electronic device through use of a display and further configured to respond to user inputs. In an example embodiment, the electronic device may include a display circuitry configured to display at least a portion of the user interface of the electronic device. The display and display circuitry may be configured to facilitate the user to control at least one function of the electronic device.

In an example embodiment, the electronic device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the electronic device may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100. The image sensor 208, alongwith other components may also be configured to capture light-field images.

These components (202-208) may communicate to each other via a centralized circuit system 210 to generate super-resolved images. The centralized circuit system 210 may be various devices configured to, among other things, provide or enable communication between the components (202-208) of the apparatus 200. In certain embodiments, the centralized circuit system 210 may be a central printed circuit board (PCB) such as a motherboard, main board, system board, or logic board. The centralized circuit system 210 may also, or alternatively, include other printed circuit assemblies (PCAs) or communication channel media.

In an example embodiment, the processor 200 is configured to, with the content of the memory 204, and optionally with other components described herein, to cause the apparatus 200 to facilitate receipt of a plurality of images, for example, images, I₁, I₂, I₃, . . . I_{N}, of a scene. In some example embodiments, the apparatus 200 may be caused to capture the plurality of images I₁, I₂, I₃, . . . I_{N}, of the scene. Alternatively, in some other example embodiments, the plurality of images I₁, I₂, I₃, . . . I_{N}, may be prerecorded, stored in an apparatus 200, or may be received from sources external to the apparatus 200. In such example embodiments, the apparatus 200 is caused to receive the plurality of images from external storage medium such as DVD, Compact Disk (CD), flash drive, memory card, or received from external storage locations through Internet, Bluetooth®, and the like.

In an example embodiment, where the media content include a video content, the plurality of images, I₁, I₂, I₃, . . . I_{N}, may include a plurality of frames of the video content associated with the scene. In an example embodiment, the plurality of frames may be successive frames of the video content of the scene. Hereinafter, the terms ‘images’ and ‘frames’ may be used interchangeably for describing various embodiments. Herein, the term ‘scene’ may refer to an arrangement (natural, manmade, sorted or assorted) of one or more objects of which images and/or videos may be captured. In an example embodiment, the scene may include at least one object in motion while the rest of the scene may be static. In another example scenario, in the scene, the background portion may be static while an object in the foreground may be in motion. For example, a scene depicting various joggers in a garden, with trees and sky in the background may include the static background portion and in-motion foreground portions. In another example scenario, the background portion of the scene may be associated with motion while the foreground portion may be static. In still another example scenario, some of the portions of the background and the foreground may be static and remaining portions of the background and the foreground of the scene may be in motion. Notwithstanding any of the above example scenarios, the scene may include at least one static portion and at least one mobile portion. In an example scenario, the plurality of images may be low-resolution input images, and the resolution of such images may be enhanced by a super resolution process.

In an example embodiment, the apparatus 200 is caused to perform an initial super-resolution of a reference image of the plurality of images based on remaining one or more images of the plurality of images. In another example embodiment, the apparatus 200 is caused to perform an initial super-resolution of a reference image of the plurality of images, based on the reference image and remaining one or more images of the plurality of images. In an example embodiment, the remaining one more images does not comprise the reference image. In other example embodiment, the remaining one more images are images other than the reference image. In an example embodiment, the reference image may be a low-resolution image. In some example embodiments, the reference image and low-resolution image may be used interchangeably. In an example embodiment, for performing the super-resolution, the processor 200 is configured to, with the content of the memory 204, and optionally with other components described herein, to cause the apparatus 200 to select one image of the plurality of images as a reference image or a base image. For example, the image I₁ may be selected as the reference image. In another example embodiment, the reference image I₁ may selected manually by a user. In an example embodiment, the remaining one or more images of the plurality of images may be selected from among the images I₂, I₃ . . . I_{N}. For example, in one scenario, the remaining images may include images I₂, I₃, and I_{N}. In another scenario, the remaining images may include images I₂, and I₃. Herein, it will be noted that in various example embodiments, the initial super-resolution of the reference image, such as the image I₁ may be performed based on either some or all of the remaining images such as the images I₂, I₃, . . . I_{N}. In an example embodiment, a processing means may be configured to perform the initial super-resolution of the low-resolution reference image h of the plurality of images based on remaining one or more other images of the plurality of images. An example of the processing means may include the processor 202, which may be an example of the controller 108.

In an example embodiment, the processor 200 is configured to, with the content of the memory 204, and optionally with other components described herein, to cause the apparatus 200 to register the remaining one or more images of the plurality of images with the reference image, and fusing the data associated with the plurality of images together, to form an initial super-resolved image. It will be noted that the registration across the remaining one or more images may be performed by any known global reconstruction algorithm, without limiting the scope of various embodiments. In an example embodiment, the registration across the remaining one or more images may be performed based on parametric registration methods or non-parametric registration methods. A parametric registration method is based on an assumption of a parametric model. The parametric registration algorithm may consist of fitting the model to the data, and estimating the parameters of the model. Examples of parametric registration algorithms may include homography, similarity transformation, and the like. The non-parametric registration algorithm is not based on any parametric model. Thus, the non-parametric model is applied for those problems where the parameterization of the problem (for example, fusion of data associated with the plurality of images) is unavailable. Example of non-parametric registration algorithms may include dense optical flow.

In an example embodiment, the registration across the plurality of images may facilitate in performing multi-frame alignment or multi-frame image super-resolution to thereby generate a super-resolution image. Herein, the term ‘multi-frame image super-resolution’ may refer to a process which may take several low resolution images (for example, the plurality of images) of the same scene, acquired under different conditions, and process the plurality of images together so as to synthesize one or more high-quality super-resolution images. In an example embodiment, the high-quality super-resolution image so generated may be associated with higher spatial frequency, and less noise and image blur than any of the plurality of images. In an example embodiment, the processor 200 is configured to, with the content of the memory 204, and optionally with other components described herein, to cause the apparatus 200 to generate the super-resolved image based on the registration of the remaining one or more images with the reference image. In an example embodiment, a processing means may be configured to register the remaining one or more images of the plurality of images with the reference image, and fusing the data associated with the plurality of images together, to form the initial super-resolved image. An example of the processing means may include the processor 202, which may be an example of the controller 108.

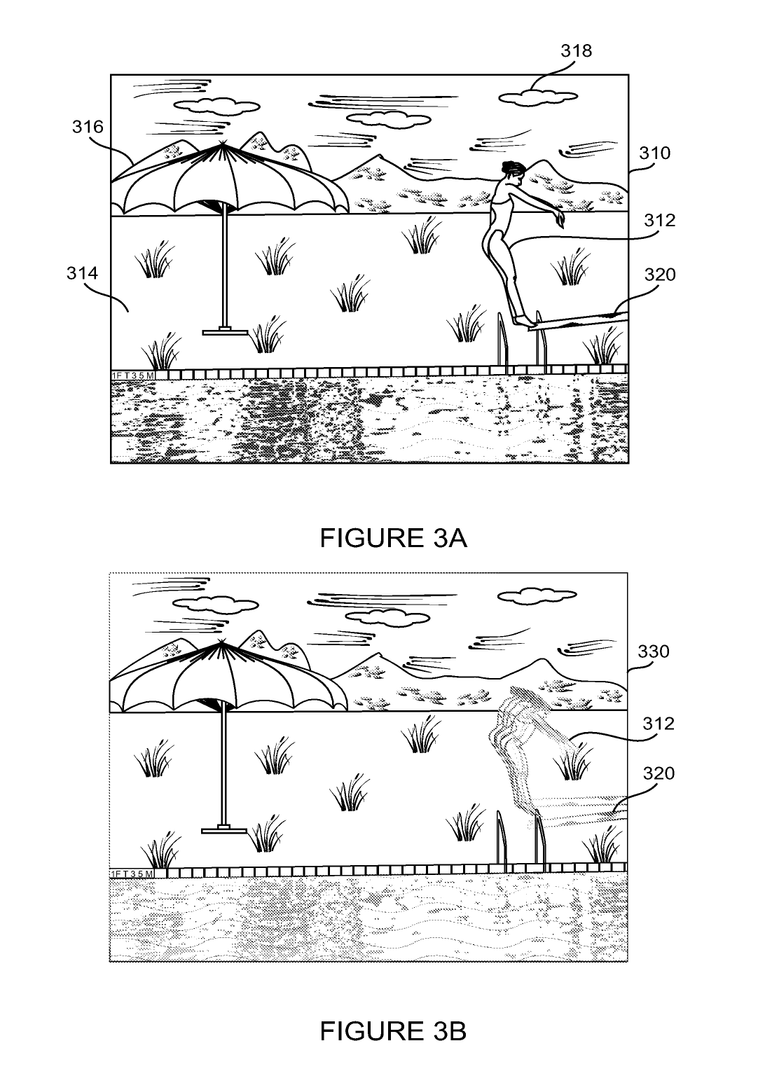

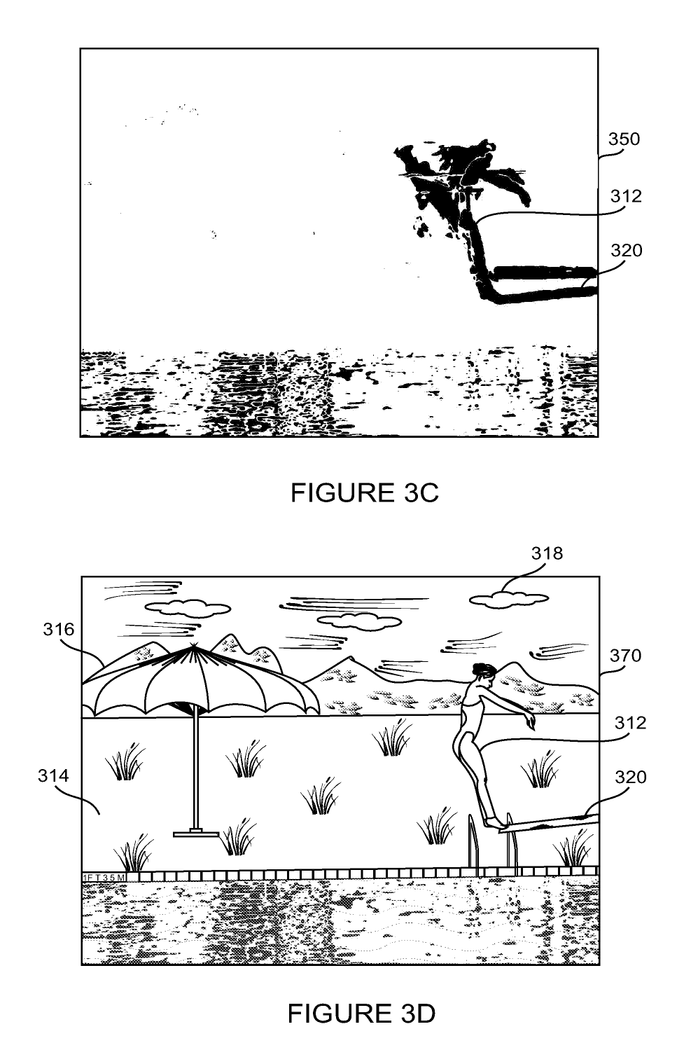

In an example embodiment, the initial super-resolved image being generated based on the registration of the remaining one or more images with the reference image may include artifacts due to the mobile objects/portions of the scene. In an example embodiment, the artifacts may be local motion artifacts that may appear in the super-resolved image due to the mobile objects/portions of the scene. In an example embodiment, the local motion artifacts may appear in the super-resolved image since, during the process of super-resolution, the local motion of the scene may be condensed into one image/frame of the super-resolved image. An example of local motion artifacts in an initial super-resolved image is illustrated and described with reference to FIG. 3B.

In an example embodiment, the processor 200 is configured to, with the content of the memory 204, and optionally with other components described herein, to cause the apparatus 200 to perform up-sampling of the reference image for generating an up-sampled reference image. In an example embodiment, the up-sampled reference image may be generated by interpolating the reference image using a suitable interpolation technique. In an example embodiment, the reference image may be interpolated by an interpolation technique, for example a cubic interpolation method. Various examples of interpolation techniques may include, cubic interpolation, 3D linear interpolation, 3D cubic interpolation, 3D Hermite interpolation, trilinear interpolation techniques, linear regression, curve fitting through arbitrary points, nearest neighbor weighted interpolation, and so on. In an example embodiment, a processing means may be configured to perform up-sampling of the reference image for generating an up-sampled reference image. An example of the processing means may include the processor 202, which may be an example of the controller 108.

In an example embodiment, the interpolation of the reference image may be performed by cubic interpolation algorithm. The cubic interpolation technique is based on the fact that if the values of a function f(x) and its derivative are known at x=0 and x=1, then the function can be interpolated on the interval [0,1] using a third degree polynomial. In an example embodiment, the cubic interpolation method utilizes the two points to the left of the interval and the two points to the right of the interval as inputs for the interpolation function. An example of interpolation of the reference frame to generate the up-sampled reference frame is illustrated and explained further with reference to FIG. 3A.

In an example embodiment, the super-resolved image includes finer details of the scene than the interpolated reference image. In an example embodiment, a difference between the super-resolved image and the interpolated reference image may provide a difference between the finer details of the scene as well as the motion of the at least one mobile object of the scene. In an example embodiment, the motion of the at least one mobile object of the scene may be determined by computing a motion mask image associated with the scene. In an example embodiment, the motion mask image may be indicative of motion of the at least one mobile object associated with the scene. In an example embodiment, the processor 200 is configured to, with the content of the memory 204, and optionally with other components described herein, to cause the apparatus 200 to generate a motion mask image based on a comparison of the super-resolved image with the interpolated (or up-sampled) reference image. In an example embodiment, the motion mask image associated with a scene may include black portions representative of mobile regions/objects of the image and white regions/objects representative of static regions of the image. The size of the motion mask image may be same or nearly same as the size of an image of the plurality of images. However, the motion mask image may be a binary image of the scene, meaning thereby that the value of pixels associated with the motion mask image may include binary values. In an example embodiment, the value ‘0’ may be assigned to the pixels associated with the at least one mobile object, and such mobile objects may be represented as black regions in the motion mask image. Also, the value ‘1’ may be assigned to the pixels associated with static portions/objects, and such static portions/objects may be represented as white regions in the motion mask. An example of the motion mask image is illustrated and described with reference to FIG. 3D.

In an example embodiment, for generating the motion mask image, a difference between the motion information associated with the initial super-resolved image and the interpolated reference image is determined. In an example embodiment, for determining the difference between the motion information of the two images, namely the initial super-resolved image and the interpolated reference image, a difference between the two images may be computed. However, the difference between the two images includes difference between the motion information, and also between the finer details of the two images. In order to capture only the difference of motion information between the two images, a difference image may be generated based on the difference of the initial super-resolved image and the interpolated reference image. The difference image may then be filtered by a low pass filtering means to generate an intermediate image. In an example embodiment, in order to convert the intermediate image into a binary image (or the motion mask image), a plurality of regions of the intermediate image may be compared with a threshold value to generate the motion mask image. For example, the regions/pixels of the intermediate image having a value of motion score thereof being greater than or equal to the threshold value may be assigned a binary value ‘0’, and the regions/pixels of the intermediate image having the value of motion score thereof being lower than the threshold value may be assigned a binary value ‘1’. Herein, the term ‘motion score’ associated with a pixel/region of the intermediate image may be indicative of quantitative assessment of the motion associated with said pixel/region. In an example embodiment, the entire motion of the at least one mobile object may be captured in the motion mask image, throughout the duration of the capture of the media content, thereby precluding a comparison of each image/frame of the video with the reference frame/reference image. In an example embodiment, the computation of motion mask image may facilitate in determining the motion associate with the scene in a computationally efficient manner.

In an example embodiment, the processor 200 is configured to, with the content of the memory 204, and optionally with other components described herein, to cause the apparatus 200 to generate, based on the motion mask image, a composite image of the scene comprising at least one portion depicting the at least one mobile object. In an example embodiment, the apparatus 200 may be caused to retrieve the at least one portion of the composite image depicting the at least one mobile object, from the up-sampled reference image. Also, the apparatus 200 may be caused to retrieve at least one remaining portion of the composite image from the initial super-resolved image. In an example embodiment, the at least one remaining portion may depict, for example, static portions of the scene, the background portion and so on.

In an example embodiment, the at least one portion and the at least one remaining portion of the composite image may be retrieved from the up-sampled reference image and the initial super-resolved image, respectively, based on the motion mask image. For example, the motion mask image may show the at least one portion in black color and the at least one another portion in white color. In an example embodiment, the composite image may be generated by fusing the super-resolved image with the interpolated reference image based on the motion mask image, to generate a composite image (Z′). In an example embodiment, the composite image (Z′) may include at least one portion corresponding to the mobile portion of the scene being replicated or retrieved from the interpolated reference image and the at least one remaining portions corresponding to the static regions of the scene being replicated or retrieved from the super-resolved image. In an example embodiment, the composite image may be generated based on the following equation:

Z′=MZ+(1−M)Z_{cubic}
where, Z′ is the composite image,
Z is the initial super-resolved image,
Z_{cubic} is the up-sampled reference image, and
M is the motion mask image with a value of ‘1’ for static regions and a value of ‘0’ for mobile regions/objects.

In another example embodiment, for generating the composite image, the processor 200 is configured to, with the content of the memory 204, and optionally with other components described herein, to cause the apparatus 200 to retrieve the at least one another portion of the composite image from the initial super-resolved image. Also, the apparatus 200 may be caused to retrieve the at least one portion of the composite image from a motion compensated super-resolved image. In an example embodiment, the at least one portion and the at least one another portion may be retrieved based on the motion mask image. Herein, the motion compensated super-resolved image may refer to an image of the scene that may be generated by performing pixel-to-pixel super-resolution of the plurality of images of the scene, so as to compensate for the motion artifacts in the initial super-resolved image.

In an example embodiment, once the motion mask image is computed, an integrated regularization is performed to deblur and sharpen the image. In an example embodiment, the regularization may be utilized for stabilizing the composite image since the regions of the composite image corresponding to the at least one mobile object are selected/retrieved from the up-sampled reference frame. In an example embodiment, the process of construction of the motion mask image and the composite image may be intrinsically unstable due to use of the plurality of images that may be low-resolution images, and therefore the composite image may be stabilized so that it is less sensitive to the errors being observed in the plurality of images. In an example embodiment, the process (reconstruction) of stabilizing the composite image may be termed as ‘regularization’. In an example embodiment, a processing means may be configured to generate the super-resolved image of the scene based on the regularization of the composite image. An example of the processing means may include the processor 202, which may be an example of the controller 108.

In an example embodiment, the processor 200 is configured to, with the content of the memory 204, and optionally with other components described herein, to cause the apparatus 200 to perform the regularization of the composite image based on following equation:

$$\underline{{X}^{⋒}} = {{ArgMin}_{\underline{x}} [ {‖ A ( H \underline{X} - \hat{\underline{Z}} ) ‖}_{⊥} + {λ}^{′} \underbrace{{\sum }_{I = - P}^{P} {\sum }_{ω = 0}^{P}}_{l ⊥ m \geq 0} {α}^{‖ ω \vert - \vert l \vert} \vert \underline{X} - {S}_{x}^{l} {S}_{y}^{m} \underline{X} ‖}_{1} ]$$

where,
\hat{Z} is the blurred high resolution image (super-resolved image), which is obtained by the registration of low resolution plurality of images followed by median.
H is blur matrix,
S^{l}ₓ, S^{m}_{y} are shift matrices in x and y directions, respectively,
X is high-resolution image of the scene,
A represents a diagonal weight matrix that determines the contribution of each pixel to the super-resolved image, and is computed as a square root of a number of measurements that contributed to the determination, and
A′ represents a modified weight matrix such that for pixels with motion, the weight is sqrt (N−1), where N is the total number of frames. In other words, a maximum weight may be assigned to the pixels with motion, so that deviation from the initially estimated values is strongly penalized in the regularization process. In an example embodiment, A′ may be represented as follows:

A′=MA+(1−M)Diag_{\sqrt{N-1}}

Some example embodiments of the generation of super-resolved images are further described in reference to FIGS. 3A-5, and these FIGS. 3A-5 represent one or more example embodiments only, and should not be considered limiting to the scope of the various example embodiments.

FIGS. 3A-3D represents example steps for generating super-resolved images associated with a scene, in accordance with an example embodiment. In an example embodiment, a media content, for example a video of the scene may be captured by a media capturing device such as the device 100. The device 100 may embody an apparatus, for example, the apparatus 200 (FIG. 2). In an example embodiment, the device may capture a video of the scene.

In an example embodiment, the scene may include a person 312 taking a dive in a swimming pool. The scene may include a beach 314, mountains 316, and sky 318, a diving board 320 and so on. The background portion of the scene including the beach 314, the mountains 316, and the sky 318 may be static while in the fore ground the person 312 is in motion (for example, preparing to take a dive in the swimming pool). Also since the person preparing to take the dive is standing on the diving board 320, the diving board 320 may also be in motion. In an example embodiment, the video content captured by the media capturing device may include a plurality of frames. The plurality of frames may be assumed to be the plurality of images associated with the scene. In an example embodiment, one of the frames/images of the scene may be selected as a reference image. In an example embodiment, the reference image may be up-sampled to generate an up-sampled image 310 by a suitable interpolation algorithm. The up-sampled image 310 is shown in FIG. 3A.

In an example embodiment, the reference image along with remaining one or more other images of the plurality of images may be processed to generate an initial super-resolved image. In an example embodiment, the initial super-resolved image may be generated based on multi-frame image resolution method. An example of the initial super-resolved image being generated based on the reference image and the remaining one or more other images of the plurality of images of the scene is shown in FIG. 3B. As shown in FIG. 3B, an initial super-resolved image 330 includes motion artifacts that may appear in the image due to mobile objects in the scene. For example, in the present example, since the person 312 standing on the diving board 320 is taking a dive and the person 312 and the diving board 320 are in motion, the super-resolved image being produced includes blurred image of the person 312 and the diving board 320.

In an example embodiment, portions of the up-sampled image 310 (FIG. 3A) may be devoid of motion artifacts, unlike the super-resolved image 330 (FIG. 3B). For example, the person 312 and the diving board 320, which are appearing blurred due to motion artifacts in the super-resolved image 330 (FIG. 3B) are shown devoid of any such artifacts in the up-sampled image 310 (FIG. 3A). Accordingly, the mobile objects such as the person 312 and the diving board 320 may be retrieved from the up-sampled reference image 310. Also, other portions associated with the scene, for example the static portions such as sky, the mountains, etc. may be retrieved from the initial super-resolved image 330. In an example embodiment, a motion mask image associated with the scene may be generated that may be indicative of the static portions and mobile portions/objects of the scene. In an example embodiment, the portions to be retrieved from the up-sampled reference image 310 and the initial super-resolved image 330 may determine based on a motion mask image. An example motion mask is illustrated in FIG. 3C.

As illustrated in FIG. 3C, a motion mask image 350 may include certain dark (or black) portions and certain light (or white) portions. In an example embodiment, the black portions of the motion mask image 350 may be indicative of the mobile portions of the scene while the white portions may be indicative of the immobile/static portions of the scene. For example, as illustrated in FIG. 3C, the portions associated with mobile objects such as the person 312 and the diving board 330 appear as black in the motion mask image 350 while the static regions i.e. rest all the regions in the image appear as white. In an example embodiment, the knowledge of the mobile regions and the static regions of the scene may facilitate in generating a high-resolution image of the scene. In an example embodiment, with the knowledge of the mobile and static regions of the scene, the pixels from the initial super-resolved image 330 (FIG. 3B) and the interpolated/up-sampled reference image 310 may be combined to form a composite image 370, as illustrated in FIG. 3D. In an example embodiment, the pixels associated with the mobile objects (appearing as black in the motion mask image 360) may be retrieved from the up-sampled image while the pixels associated with the static regions (appearing as white in the motion mask) may be retrieved from the super-resolved image to generate the composite image 370. In an example embodiment, the composite image 370 may be filtered by passing through a low-pass filter to thereby remove noise components from the composite image 370. In an example embodiment, the filtering of the composite image 370 may be performed based on a predetermined threshold value of noise level associated with the pixels of the image.

In an example embodiment, the composite image may be regularized for blurring and sharpening. In an example embodiment, the regularization of the composite image may be performed based on the following expression:

$$\underline{{X}^{⋒}} = {{ArgMin}_{\underline{x}} [ {‖ A ( H \underline{X} - \hat{\underline{Z}} ) ‖}_{⊥} + {λ}^{′} \underbrace{{\sum }_{I = - P}^{P} {\sum }_{ω = 0}^{P}}_{l ⊥ m \geq 0} {α}^{‖ ω \vert - \vert l \vert} \vert \underline{X} - {S}_{x}^{l} {S}_{y}^{m} \underline{X} ‖}_{1} ]$$

such that

Z′=MZ+(1−M)Z_{cubic}

A′=MA+(1−M)Diag_{\sqrt{N-1}}
where,
\hat{Z} is the blurred high resolution image (super-resolved image), which is obtained by the registration of low resolution plurality of images followed by median.
H is blur matrix,
S^{l}ₓ, S^{m}_{y} are shift matrices in x and y directions, respectively,
X is high-resolution image of the scene,
A represents a diagonal weight matrix that determines the contribution of each pixel to the super-resolved image, and is computed as a square root of a number of measurements that contributed to the determination, and
A′ represents a modified weight matrix such that for pixels with motion, the weight is sqrt (N−1), where N is the total number of frames. In other words, a maximum weight may be assigned to the pixels with motion, so that deviation from the initially estimated values is strongly penalized in the regularization process.

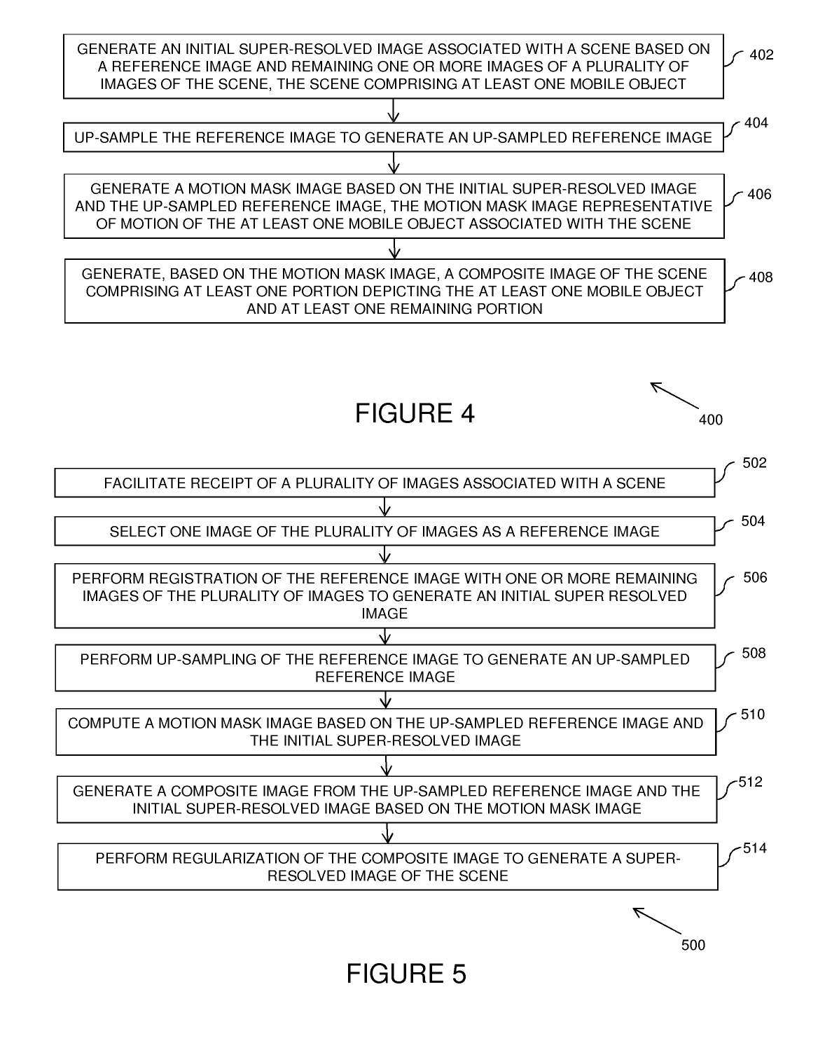

FIG. 4 is a flowchart depicting an example method 400 for generating super-resolved images associated with a scene, in accordance with an example embodiment. The method 400 depicted in the flow chart may be executed by, for example, the apparatus 200 of FIG. 2.

In an example embodiment, the super-resolved image may be generated based on a plurality of images associated with a scene. As described in reference to FIG. 2, the plurality of images may be received from a media capturing device having a light-field camera, or from external sources such as DVD, Compact Disk (CD), flash drive, memory card, or received from external storage locations through Internet, Bluetooth®, and the like. In an example embodiment, the plurality of images of a scene may be a plurality of frames of a video content associated with the scene. In an example embodiment, the plurality of frames may be consecutive frames, and may capture motion of the various objects of the scene. In an example embodiment, the scene may include at least one mobile object.

At 402, the method 400 includes generating an initial super-resolved image associated with the scene based on a reference image and remaining one or more images of the plurality of images of the scene. In an example embodiment, the plurality of images may be registered based on the reference image, and the registered images may be combined to form the initial super-resolved image. In an example embodiment, a process of fusing the data and during registration across the plurality of images may be performed by a global registration algorithm. At 404, an up-sampled reference frame may be generated by interpolating the reference frame using a suitable interpolation technique. In an example embodiment, the reference frame may be interpolated by an interpolation technique, for example a cubic interpolation method. An example up-sampled reference image is illustrated and described with reference to FIG. 3A.

At 406, a motion mask image may be generated based on the super-resolved image and the up-sampled reference image. The motion mask image may be representative of motion of the at least one mobile object associated with the scene. In an example embodiment, the motion mask associated with a scene may include black portions representative of mobile regions of the image and white regions representative of static regions of the image. An example motion mask image is illustrated and explained with reference to FIG. 3C.

At 408, based on the motion mask image, a composite image of the scene having at least one portion depicting the at least one mobile object and at least one remaining portion may be generated. In an example embodiment, the at least one remaining portion may depict, for example, static portions of the scene, the background portion and so on. In an example embodiment, the initial super-resolved image may be fused with the up-sampled reference image based on the motion mask image to generate a composite image of the scene. In an example embodiment, the fusing the up-sampled reference image with the initial super-resolved image may be performed based on a weighted sum of the initial super-resolved image and the up-sampled reference image. For example, the fusion may be performed based on the following equation:

Z′=MZ+(1−M)Z_{cubic}

where,
Z′ is the composite image,
Z is the initial super-resolved image,
Z_{cubic} is the up-sampled reference image, and
M is the motion mask image.

In an example embodiment, the composite image may include portions having the mobile object and static objects, where the portions having the mobile objects are retrieved from the up-sampled reference image and the portions having the statics objects are retrieved from the initial super-resolved image. In an example embodiment, the composite image may be regularized to generate a super-resolved image of the scene.

In another example embodiment, the composite image may be generated by retrieving the at least one another portion associated with the mobile portions/objects of the composite image from the initial super-resolved image, and the at least one portion from a motion compensated super-resolved image. In an example embodiment, the at least one portion and the at least one another portion may be retrieved based on the motion mask image.

FIG. 5 is a flowchart depicting example method 500 for generating super-resolved images, in accordance with another example embodiment. The methods depicted in these flow charts may be executed by, for example, the apparatus 200 of FIG. 2. Operations of the flowchart, and combinations of operation in the flowcharts, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods are described with help of apparatus 200. However, the operations of the methods can be described and/or practiced by using any other apparatus.

At block 502, the method 500 includes facilitating receipt of a plurality of images of a scene. In an example embodiment, the scene may include at least one mobile object. For example, in a scene the background portion may be static while at least one object in the foreground may be in motion. In another example scenario, at least one object in the background may be motion while the foreground portion may be static. In still another example scenario, some of the portions of the background and the foreground may be static and remaining portions of the background and the foreground of the scene may be in motion. Notwithstanding any of the above example scenarios, the scene may include at least one static portion and at least one mobile portion/object. In an example embodiment, the plurality of images of a scene may be a plurality of frames of a video content associated with the scene. In an example embodiment, the plurality of frames may be consecutive frames, and may capture motion of the various objects of the scene.

In an example scenario, the plurality of images may be low-resolution input images, and resolution of such images may be enhanced by a super-resolution process. For performing the super-resolution, one image of the plurality of images may be selected as a reference image. In an example embodiment, warping (or registration) may be performed across remaining one or more images of the plurality of images based on the reference image, at 506. In an example embodiment, the data associated with the plurality of warped images may be combined to form the initial super-resolved image. In an example embodiment, the process of fusing the data across the plurality of images may be performed by a global registration algorithm. It will be noted that the registration across the remaining one or more images may be performed by any known global registration algorithm, without limiting the scope of various embodiments. In an example embodiment, the registration across the plurality of images may facilitate in performing multi-frame alignment or multi-frame image super-resolution to thereby generate an initial super-resolved image.

At 508, an up-sampling of the reference image may be performed for generating an up-sampled reference image. In an example embodiment, the up-sampled reference frame may be generated by interpolating the reference image using a suitable interpolation technique. In an example embodiment, the reference image may be interpolated by an interpolation technique, for example a cubic interpolation method.

At 510, a motion mask image may be computed based on the up-sampled reference image and the initial super-resolved image. In an example embodiment, the motion mask associated with a scene may include black portions representative of mobile regions of the image and white regions representative of static regions of the image. An example motion mask image is illustrated and explained with reference to FIG. 3C.

In an example embodiment, the motion mask image may be generated by comparing the initial super-resolved image with the interpolated reference image to generate a difference image. In an example embodiment, a low-pass filtering may be applied to the difference image to generate an intermediate image. The motion mask image may be generated based on a comparison of a plurality of regions of the intermediate image with a threshold value. At 512, a composite image from the up-sampled reference image and the super-resolved image may be generated based on the motion mask image. In an example embodiment, the composite image (Z′) may include regions corresponding to the mobile portion/objects of the scene being replicated from the interpolated reference image and the regions corresponding to the static regions/objects of the scene being replicated from the initial super-resolved image. At 514, regularization of the composite image is performed to generate a super-resolved image. In an example embodiment, the regularization of the composite image facilitates in de-blurring and sharpening the composite image so as to generate a high-resolution super-resolved image without motion artifacts.

Without in any way limiting the scope, interpretation, or application of the claims appearing below, a technical effect of one or more of the example embodiments disclosed herein is to generate super-resolved images from a video content or a sequence of a plurality of images. Various embodiments provide methods for generating super-resolved image of a scene based on a motion detection associated with the scene. Accordingly, the embodiments disclose an integrated super-resolution method for handling both static and mobile objects/regions associated with the scene. In an example embodiment, an image regularization method is disclosed where an initial super-resolved image being generated from the plurality of images is fused with an up-sampled reference image being generated by up sampling a reference image from among the plurality of images, to generate a composite image of the scene. The composite image may be regularized to generate the super-resolved image of the scene. The method for generating the super-resolved image handles both static as well as mobile regions of the scene. Moreover, herein the detection of mobile objects is performed in a low-complexity manner. Also, the image regularization is performed using detected mobile regions, thereby generating a high quality super-resolved image that is devoid of motion artifacts.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A non-transitory computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various embodiments are set out in the independent claims, other embodiments comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-41. (canceled)

42. A method comprising:
generating an initial super-resolved image associated with a scene based on a reference image and remaining one or more images of a plurality of images of the scene, the scene comprising at least one mobile object;
up-sampling the reference image to generate an up-sampled reference image;
generating a motion mask image based on the initial super-resolved image and the up-sampled reference image, the motion mask image representative of motion of the at least one mobile object associated with the scene; and
generating, based on the motion mask image, a composite image of the scene comprising at least one portion depicting the at least one mobile object.

43. The method as claimed in claim 42, wherein the initial super-resolved image being generated based on a global super-resolving reconstruction algorithm.

44. The method as claimed in claim 42, wherein the up-sampled reference image being generated by interpolating the reference image using cubic interpolation algorithm.

45. The method as claimed in claim 42, wherein generating the motion mask image comprises:
comparing the initial super-resolved image and the up-sampled reference image to generate a difference image;
applying a low-pass filtering to the difference image to generate an intermediate image; and
generating the motion mask image based on a comparison of a plurality of regions of the intermediate image with a threshold value.

46. The method as claimed in claim 42, wherein generating the composite image comprises:
retrieving, from the up-sampled reference image, the at least one portion of the composite image depicting the at least one mobile object based on the motion mask image; and
retrieving, from the initial super-resolved image, at least one remaining portion of the composite image based on the motion mask image, the at least one remaining portion being indicative of static objects of the scene.

47. The method as claimed in claim 42, further comprising fusing the initial super-resolved image and the up-sampled reference image based on the following equation:
Z′=MZ+(1−M)Z_{cubic}
where,
Z′ is the composite image,
Z is the initial super-resolved image,
Z_{cubic} is the up-sampled reference image, and
M is the motion mask image.

48. The method as claimed in claim 42, wherein generating the composite image comprises:
retrieving, from the initial super-resolved image, the at least one another portion of the composite image based on the motion mask image; and
retrieving, from a motion compensated super-resolved image, at least one remaining portion of the composite image based on the motion mask image, the at least one remaining portion being indicative of static objects of the scene.

49. An apparatus comprising:
at least one processor; and
at least one memory comprising computer program code, the at least one memory and the computer program code configured to, with the at least one processor, cause the apparatus to at least perform:
generate an initial super-resolved image associated with a scene based on a reference image and remaining one or more images of a plurality of images of the scene, the scene comprising at least one mobile object,
up-sample the reference image to generate an up-sampled reference image,
generate a motion mask image based on the initial super-resolved image and the up-sampled reference image, the motion mask image representative of motion of the at least one mobile object associated with the scene, and
generate, based on the motion mask image, a composite image of the scene comprising at least one portion depicting the at least one mobile object.

50. The apparatus as claimed in claim 49, wherein the initial super-resolved image being generated based on a global super-resolving reconstruction algorithm.

51. The apparatus as claimed in claim 49, wherein the up-sampled reference image being generated by interpolating the reference image using cubic interpolation algorithm.

52. The apparatus as claimed in claim 51, wherein for generating the motion mask image, the apparatus is further caused, at least in part to:
compare the initial super-resolved image and the up-sampled reference image to generate a difference image;
apply a low-pass filtering to the difference image to generate an intermediate image; and
generate the motion mask image based on a comparison of a plurality of regions of the intermediate image with a threshold value.

53. The apparatus as claimed in claim 49, wherein for generating the composite image, the apparatus is further caused, at least in part to:
retrieve, from the up-sampled reference image, the at least one portion of the composite image depicting the at least one mobile object based on the motion mask image; and
retrieve, from the initial super-resolved image, at least one remaining portion of the composite image based on the motion mask image, the at least one remaining portion being indicative of static objects of the scene.

54. The apparatus as claimed in claim 49, wherein the apparatus is further caused, at least in part to fuse the initial super-resolved image and the up-sampled reference image based on the following equation:
Z′=MZ+(1−M)Z_{cubic}
where,
Z′ is the composite image,
Z is the initial super-resolved image,
Z_{cubic} is the up-sampled reference image, and
M is the motion mask image.

55. The apparatus as claimed in claim 49, wherein for generating the composite image, the apparatus is further caused, at least in part to:
retrieve, from the initial super-resolved image, the at least one another portion of the composite image based on the motion mask image; and
retrieve, from a motion compensated super-resolved image, at least one remaining portion of the composite image based on the motion mask image, the at least one remaining portion being indicative of static objects of the scene.

56. A computer program product comprising at least one computer-readable storage medium, the computer-readable storage medium comprising a set of instructions, which, when executed by one or more processors, cause an apparatus to at least perform:
generate an initial super-resolved image associated with a scene based on a reference image and remaining one or more images of a plurality of images of the scene, the scene comprising at least one mobile object,
up-sample the reference image to generate an up-sampled reference image,
generate a motion mask image based on the initial super-resolved image and the up-sampled reference image, the motion mask image representative of motion of the at least one mobile object associated with the scene, and
generate, based on the motion mask image, a composite image of the scene comprising at least one portion depicting the at least one mobile object.

57. The computer program product as claimed in claim 56, wherein the initial super-resolved image being generated based on a global super-resolving reconstruction algorithm.

58. The computer program product as claimed in claim 56, wherein the up-sampled reference image being generated by interpolating the reference image using cubic interpolation algorithm.

59. The computer program product as claimed in claim 56, wherein for generating the motion mask image, the apparatus is further caused, at least in part to:
compare the initial super-resolved image and the up-sampled reference image to generate a difference image;
apply a low-pass filtering to the difference image to generate an intermediate image; and
generate the motion mask image based on a comparison of a plurality of regions of the intermediate image with a threshold value.

60. The computer program product as claimed in claim 56, wherein for generating the composite image, the apparatus is further caused, at least in parts to:
retrieve, from the up-sampled reference image, the at least one portion of the composite image depicting the at least one mobile object based on the motion mask image; and
retrieve, from the initial super-resolved image, at least one remaining portion of the composite image based on the motion mask image, the at least one remaining portion being indicative of static objects of the scene.

61. The computer program product as claimed in claim 56, wherein for generating the composite image, the apparatus is further caused, at least in part to:
retrieve, from the initial super-resolved image, the at least one another portion of the composite image based on the motion mask image; and
retrieve, from a motion compensated super-resolved image, at least one remaining portion of the composite image based on the motion mask image, the at least one remaining portion being indicative of static objects of the scene.
